(19) United States
(12) Patent Application Publication
(10) Pub. No.: US 2002/0099606 A1
(43) Pub. Date: Jul. 25, 2002

(54) Radius advertising system and method

(76) Inventor: Wolf Shlagman, Miami Beach, FL (US)

Correspondence Address: LOTT & FRIEDLAND, P.A., P.O. BOX 141098, CORAL GABLES, FL, 33114-1098, US

(21) Appl. No.: 09/989,307

(22) Filed: Nov. 20, 2001

Related U.S. Application Data
(60) Provisional application No. 60/249,984, filed on Nov. 20, 2000.

(51) Int. Cl. G06F 17/60

(52) U.S. Cl. 705/14

(57) ABSTRACT

An automated online, multi-featured advertisement system is disclosed which uses radius-based algorithms as well as latitude and longitude coordinates to specify online community within which specific advertisements are to be displayed.

### CROSS REFERENCE TO RELATED APPLICATIONS

Pursuant to 35 U.S.C. §119(e), this application claims priority based on U.S. Provisional Patent Application Ser. No. 60/249,984, entitled “Radius Advertising Method and Apparatus” filed Nov. 20, 2000.

### BACKGROUND OF INVENTION

This invention relates to advertising through global online computer networks and specifically to a World Wide Web-based automated online, multi-featured advertising system that uses radius-based algorithms and the geographic location of the targeted audience to specify what advertisements are displayed.

This invention relates to a new method and apparatus for online advertising through the World Wide Web which provides advertisements targeted to an audience defined by its geographic location.

With the advent and proliferation of global computer networks, and namely the Internet, there has been an increased need by traditional businesses to establish a presence in the online world. There has also been a surge of new businesses specifically geared towards the Internet. As with traditional media such as television, radio and newspapers, one of the general models for Internet businesses has been to provide novel and useful services which are free of charge or low in cost to the users but are underwritten by advertisements to which the users are exposed.

The general goal of advertisers is to entice their audience to purchase the advertised goods or services or to generally improve the image of the company, service or product they are promoting. This goal is most efficiently achieved when advertisements are specifically targeted towards an audience which fits within a profile that is desirable to the advertiser. Audience profiles can be broken up based on various factors such as, for example, age, income, gender, and the like. Another factor which advertisers generally use to target their message, and which is the subject of the present invention, is the geographic location of the audience.

Geographically targeted advertisement is attractive to businesses because it is generally viewed as one of the most cost efficient methods of advertising. This holds especially true for businesses which require that their customers travel to a storefront location in order to make a purchase. An example of such a business is a traditional auto dealership whose primary targets are local residents within a certain geographic radius of its showroom. For such a business, it would be a waste of resources to distribute an advertisement over a widespread geographic region in which a large segment of the population is located too far away to ever travel to the showroom. It is much more cost efficient for the auto dealership to advertise using methods which can target only those potential customers which are geographically located within its immediate vicinity.

In traditional media such as newspapers, radio, and television, targeting advertisements by geographic region is a relatively simple matter. This is so because traditional media is generally distributed with an built-in geographic audience in mind. That is to say, traditional media can generally control the geographic area within which it is distributed and can market its areas of distribution to advertisers as a way to maximize their advertisement budget. Accordingly, if, for example, a swimsuit manufacturer wanted to target its advertisements to individuals who are more likely to purchase its products, it can choose to publish advertisements in newspapers which are distributed only within warm-weather cities.

One of the main advantages of the Internet to advertisers is its global reach and the inherent ability to simultaneously reach millions of consumers. This, however, presents an immense challenge to advertisers who wish to target their message by geographic region. Geographically targeted advertisement is much more difficult in the Internet than with traditional media because there is no built-in inherent geographic limitation to the reach of a particular advertisement. Any particular web site on the Internet can be viewed by individuals from around the world and it is generally not known to, or within the control of, the advertiser where the viewers of an advertisement are located. Therefore, Internet advertisement as a whole has been ineffective and cost prohibitive for businesses who rely on a local customer base for their sales.

From the standpoint of the advertiser's audience, geographically targeted advertisements are also beneficial. One of the biggest complaints of Internet users is “spam”, and more generally, unsolicited online advertisements. Unsolicited advertisements are generally considered a great annoyance because the overwhelming majority of people who receive them would never be interested in the products or services they promote. This, in part, is due to the fact that the product or service advertised can only be purchased from, or is useful in, a geographic region in which the reader of the advertisement does not reside. In addition to being wasteful, untargeted advertisements can have a negative impact on the image of the advertiser by creating an association between it and the annoyance caused by unsolicited advertisement and “spam.”

Consequently, there is a need in the art for an online advertising system whereby the advertiser can target Internet advertisements based on the geographic location of the advertisement's desired audience.

There is a further need in the art for an online advertising system that permits advertisers to specify a geographic region limiting the area within which advertisements are distributed to viewers.

There is a further need in the art for an online advertising system that permits advertisers to quickly and easily modify the geographic region in which advertisements are displayed.

There is a further need in the art for an online advertising system which permits a computer user to specify his or her geographic location in order to receive specifically targeted advertisements for products and/or services which are useful at or near said geographic location.

### SUMMARY OF INVENTION

The present invention is an automated online, multi-featured advertisement system that uses radius-based algorithms as well as latitude and longitude coordinates to specify the online community within which specific advertisements are to be displayed. An online community consist of a web site or a set of web sites which are directed towards individuals who are residents of, or are interested in, a common geographic region.

The present invention operates in conjunction with a Platform Service which consists of an Internet portal providing local information to the online residents of a plurality of geographic regions. The Platform Service is accessible to users of the Internet equipped with a standard Internet connection (such as, for example, dial-up, cable, DSL, ISDN, LAN, T1, T3, and the like) and a commercial Internet browser (such as, for example, Microsoft Internet Explorer, Netscape, Opera, and the like). The Platform Service provides a number of online communities which are directly related to the geographic regions covered by the Platform Service. Within the Platform Service, a user can become a member of an online community (or communities) which he or she is interested in. Preferably, a user will become a member of an online community linked to a geographic area in which he or she lives, works or spends significant time.

Upon navigating an online community, a member is presented with information about local events, weather and the like, as well as advertisements tailored for the particular geographic region mirrored by the online community.

The present invention permits local and national advertisers to designate a geographic Base location or several Base locations from which to promote a number of advertising products that are supported by the Platform Service. Once the Base location or locations have been selected for and advertisement or advertisements, the advertiser can select a radial distance from each Base location through which the advertisement is to be displayed. The Base locations and radial distances delineate a circular geographic areas within which the advertiser wishes to display the advertisement to members of relevant online communities. The subject advertisement is then delivered to members of online communities whose geographic equivalent falls within the selected advertisement display areas.

The present invention permits advertisers to fine-tune the advertisement display areas by simply changing the Base location and/or radial distance for one or more advertisements. These changes can be performed in almost instantaneous fashion and can be observed almost immediately.

The present invention distinguishes itself from other online advertising programs in that it combines the inherent benefits of online advertising (for example, widespread reach, low production costs for advertisements, advertisements can be quickly and easily changed) with a mechanism that allows positioning of advertisements within discrete geographic regions that can be as narrow or widespread as the advertiser wishes them to be.

Accordingly, it is an object of the present invention to provide an online advertising system whereby the advertiser can target Internet advertisements based on the geographic location of the advertisement's desired audience.

It is another object of the present invention to provide an online advertising system that permits advertisers to specify a geographic region limiting the area within which advertisements are distributed to viewers.

It is another object of the present invention to provide an online advertising system that permits advertisers to quickly and easily modify the geographic region in which advertisements are displayed.

It is another object of the present invention to provide an online advertising system which permits a computer user to specify his or her geographic location in order to receive specifically targeted advertisements for products and/or services which are useful at or near said geographic location.

### BRIEF DESCRIPTION OF DRAWINGS

FIGS. 7a and 7b represent a web page for the preferred embodiment of the present invention illustrating the advertiser registration feature.

FIGS. 2a and 2b represent a web page for the preferred embodiment of the present invention illustrating the choices available to an advertiser for adding a new advertisement into the system.

FIG. 3 represents a web page for the preferred embodiment of the present invention illustrating the full registration screen available to the user.

FIG. 4 represents a web page for the preferred embodiment of the present invention illustrating the simplified zip code entry screen available to the user.

FIG. 5 represents a web page for the preferred embodiment of the present invention illustrating a sample “home” page for a particular geographic area.

FIG. 6 represents a web page for the preferred embodiment of the present invention illustrating the “home” page choices screen.

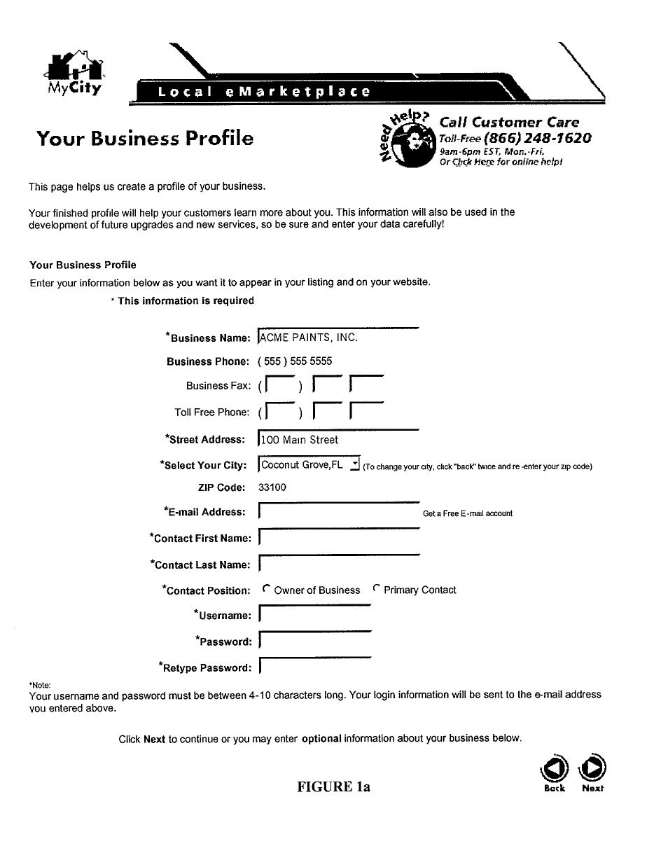

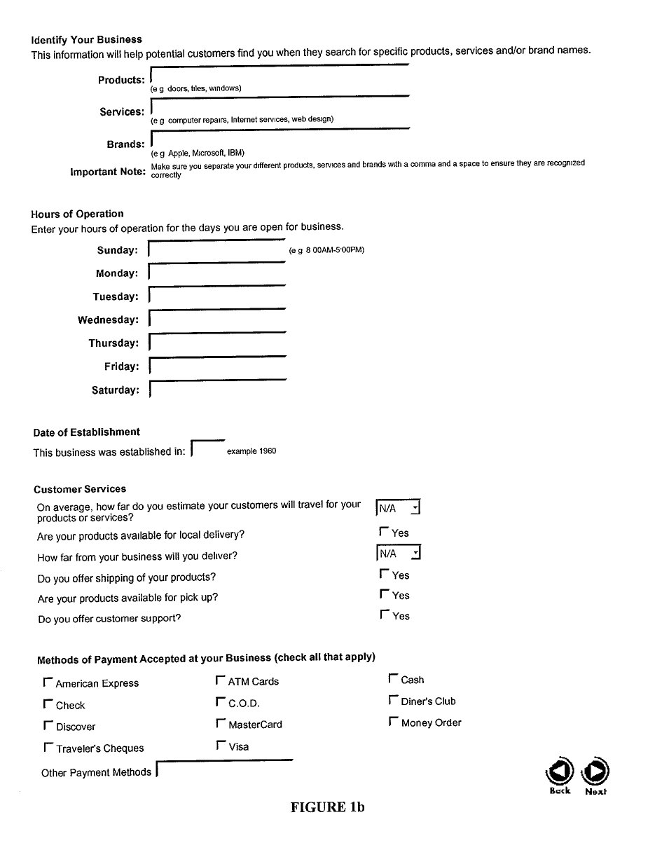

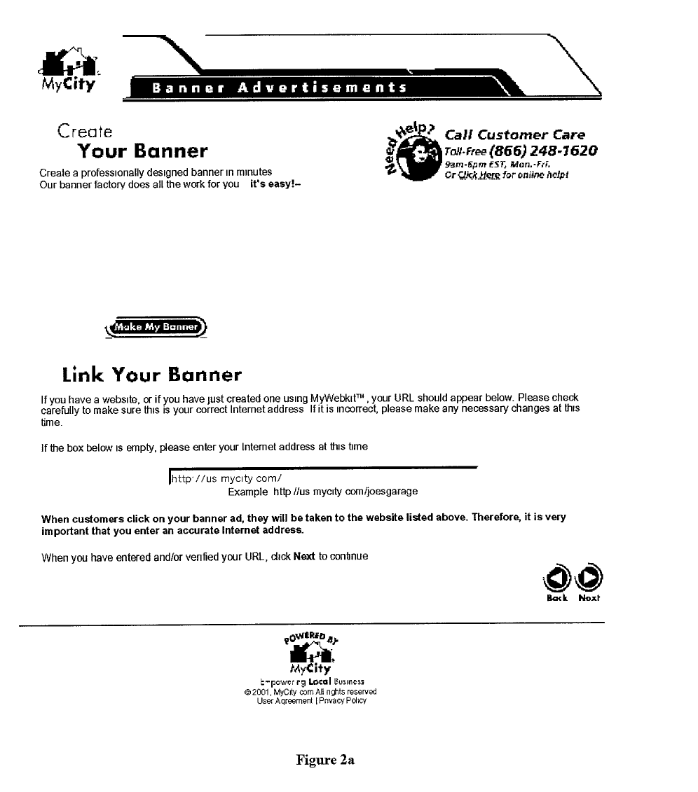

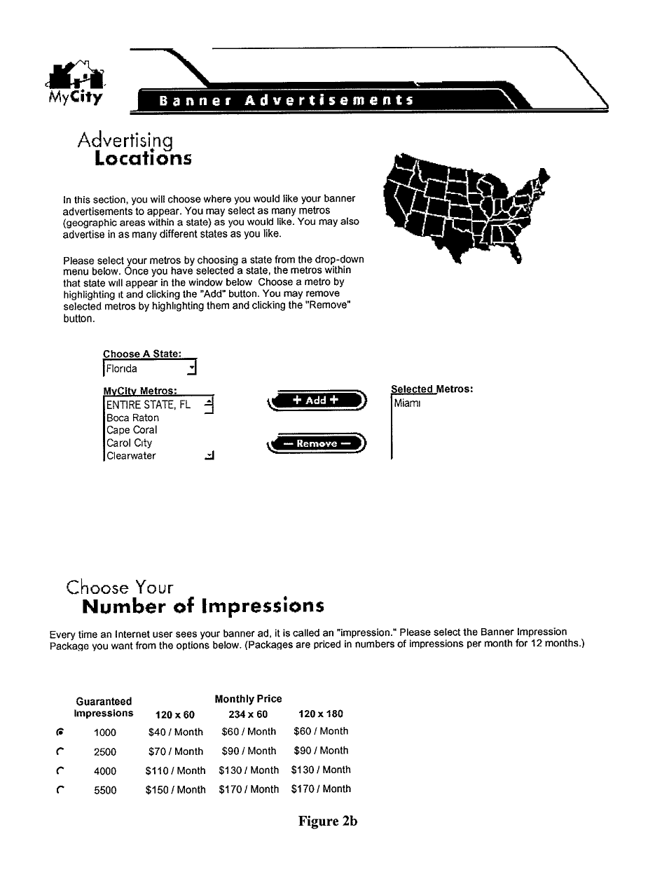

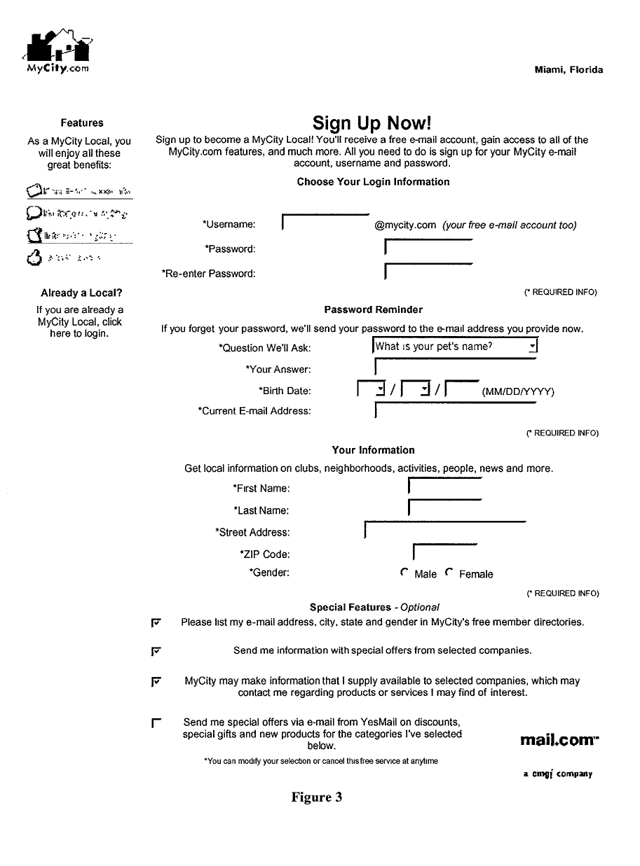

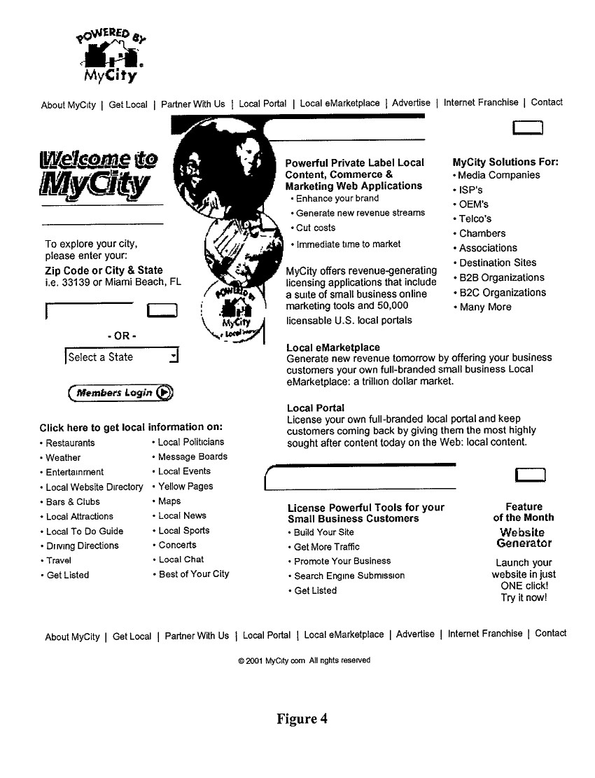

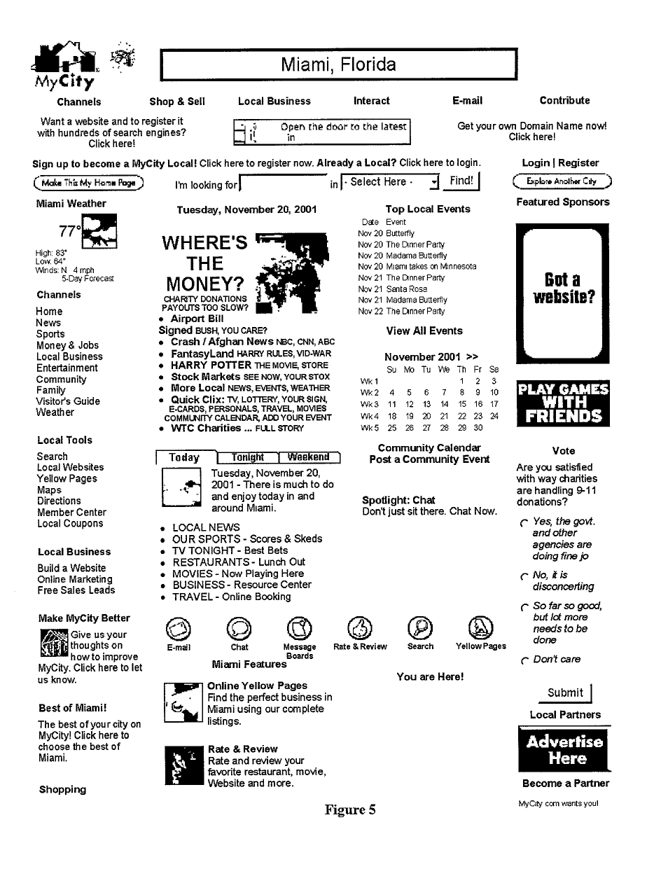

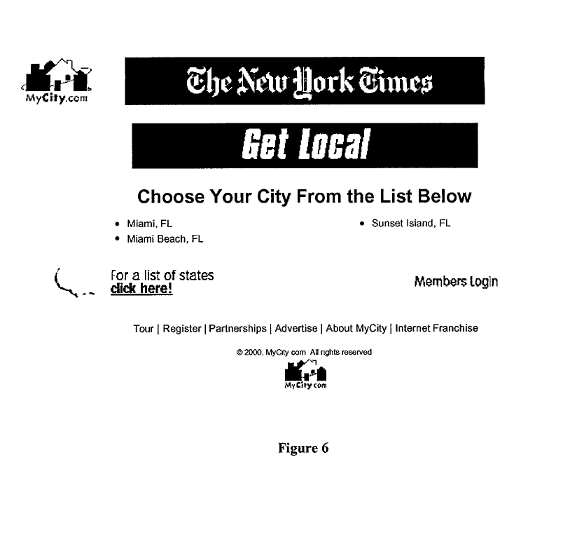

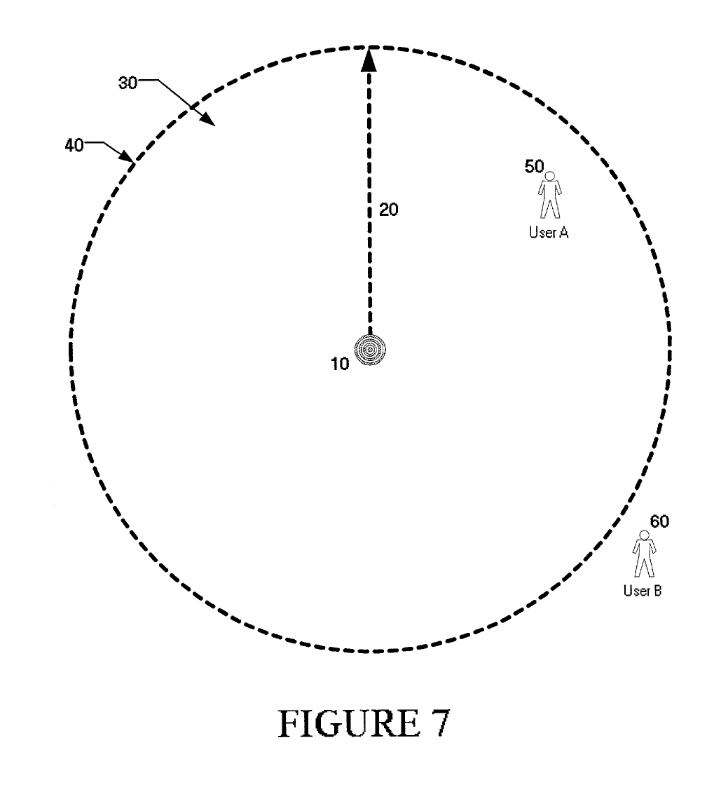

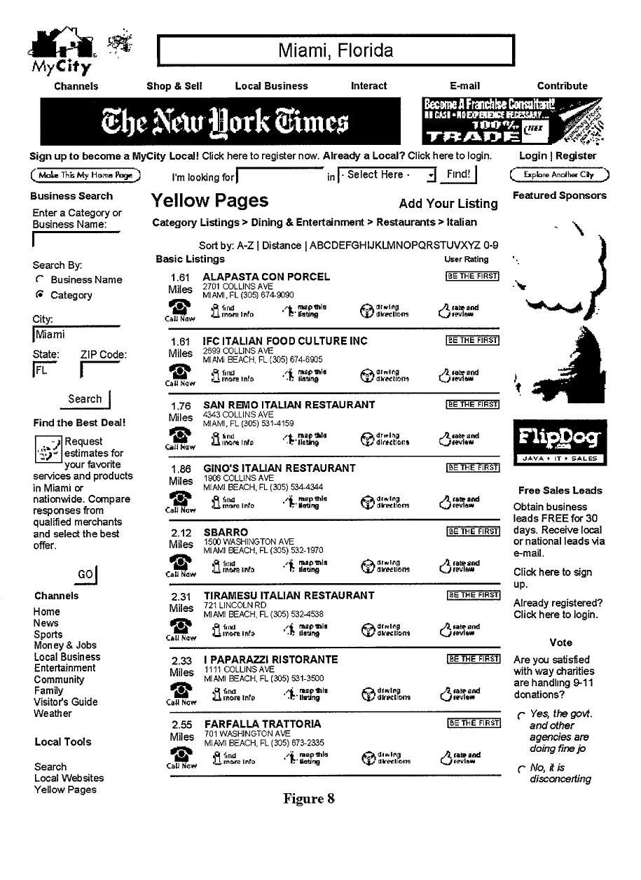

FIG. 7 illustrates the relationship between a particular advertisement's Base location, its radius, its display footprint and the location of the user.

FIG. 8 represents a web page generated by the preferred embodiment of the present invention illustrating an informational advertisement listing.

### DETAILEDE DESCRIPTION

In the preferred embodiment of the present invention, a Platform System is provided which serves as the basis upon which the invention operates. The Platform Service is accessible to users of the Internet equipped with a standard Internet connection (such as, for example, dial-up, cable, DSL, ISDN, LAN, T1, T3, and the like) and a commercial Internet browser (such as, for example, Microsoft Internet Explorer, Netscape, Opera, and the like).

The Platform System is similar to a traditional Internet portal providing information of interest to residents of approximately 50,000 discrete geographic communities throughout the United States. The Platform System provides hierarchically-ordered content of local interest which attracts viewers (hereinafter “users”) to its main website and provides the framework upon which various online communities, which mirror the geographic communities, are formed. The online communities themselves are comprised of web pages which are dynamically generated to combine content and advertisements which are customized to match the geographic location of the user.

All web pages of the Platform Service are generated dynamically from a set of databases (hereinafter “core databases”) which contain information about users, advertisements, online content, and the like. The three main core databases in the preferred embodiment of the present invention are the User Table, the Ad Table and the Geo Table.

In order to generate relevant advertisement for appropriate users, records in the User Table and Ad Table databases are appended or “tagged” with geographic parameters. The tagging of user and advertisement records are essential steps to the operation of the present invention.

In a preferred embodiment of the present invention, a typical user enters the main page of the Platform Service and makes choices related to his or her geographic location which are cross-referenced against the core databases. Upon cross-referencing, URL Strings are dynamically created which are in turn interpreted by a web server to create and fetch the appropriate web pages to display to the user. If within the core databases there are advertisements which match the choices made by the user and whose geographic display area, or “footprint”, encompasses the geographic location of the user, such advertisements are also displayed.

The initial step in the preferred embodiment of the present invention involves the creation of a database which contains the required basic information about the geographic communities covered by the Platform System. The first of the three core databases used by the system, the Geo Table, is populated by the operator of the system with geographic information about every zip code covered by the Platform Service. A typical record in the Geo Table has the following general structure:

Typical Geo Table Record

| | | | | COUN- | | | | |
|---|---|---|---|---|---|---|---|---|
| ZIP | +4 | LONG | LAT | TY | STATE | CITY | STREET | POP |
| — | — | — | — | — | — | — | — | — |
| — | — | — | — | — | — | — | — | — |

Where “ZIP” is the postal zip code identifier for the record, “+4” is the postal zip+4 code for the record, “LONG” and “LAT” are the longitude and latitude for the geographic center of the region delineated by the zip code, “COUNTY” “STATE” and “CITY” are the county, state and city where the zip code is located, “STREET” is an established street address associated with the zip code, and “POP” is the population of the zip code. The Geo Table is, in essence, a “look-up” table that contains information which is used by the other two core databases to populate advertising and user records.

The next step in the process is for advertisers register and provide their initial base location in the form of a zip code or a zip+4. FIGS. 1a and 1b represents a web page for the preferred embodiment of the present invention illustrating the advertiser registration feature. Once the advertiser is registered, the advertiser can create and upload advertisements into the system. Each form of advertisement, such as banners, text and integrated content, has its own record associated with it in the Ad Table database. The Ad Table associates each advertisement with a base geographic location and a radius which defines the geographic footprint for display of the advertisement. A typical record in the Ad Table has the following general structure:

Typical Ad Table Record

| AD ID | ZIP | +4 | LONG | LAT | RADIUS |
|---|---|---|---|---|---|
| — | — | — | — | — | — |
| — | — | — | — | — | — |

Where “AD ID” is a unique identifier assigned to each advertisement, “ZIP” is the postal zip code for the base location assigned to the advertisement, “+4” is the postal zip+4 code for the base location assigned to the advertisement, “STREET” is the street address information for the base location assigned to the advertisement, “LAT” is the latitude of the base location associated with the advertisement, “LONG” is the longitude of the base location associated with the advertisement, and “RADIUS” is the length (in miles) of the display radius associated with the advertisement. The “AD ID” is automatically assigned by the system upon creation of an advertisement and its associated Ad Table record

By default, the initial “ZIP” and “+4” fields are assigned the base zip code and zip+4 information of the advertiser which the advertiser provides upon registration. However, the base location for each advertisement can be changed from this default location by the advertiser. The base latitude and longitude figures are obtained by looking up the zip code or zip+4 in the Geo Table and extracting the corresponding “LONG” and “LAT” values. The display radius is a particular distance in miles, chosen by the advertiser, away from the base location of the advertisement.

It should be noted that it is possible for an advertisement to have multiple base locations each with a different display radius if the advertiser wanted it to.

FIGS. 2a and 2b represents a web page for the preferred embodiment of the present invention illustrating the choices available to an advertiser for adding a new advertisement into the system.

The next step in the process occurs when a new user accesses the system. Upon accessing, a user provides either a zip code, a zip+4 or detailed street address information, depending on whether the user follows the full registration procedure or not. FIGS. 3 and 4 represent web pages for the preferred embodiment of the present invention illustrating the full registration and simplified zip code entry screens available to the user. A unique record is created for each user in the User Table using this information. A typical record in the User Table has the following general structure:

Typical User Table Record

| USER ID | ZIP | +4 | STREET | LONG | LAT |
|---|---|---|---|---|---|
| — | — | — | — | — | — |
| — | — | — | — | — | — |

Where “USER ID” is a unique identifier assigned to each user, “ZIP” is the postal zip code for the user, “+4” is the postal zip code extension, “STREET” is the street address information, “LAT” is the latitude associated with the user's zip code, zip+4 or street address, and “LONG” is the longitude associated with the user's zip code, zip+4 or street address. The latitude and longitude figures are obtained by looking up the zip code, zip+4 or street address in the Geo Table and extracting the corresponding “LONG” and “LAT” values.

Once geographic information is provided by the user, the user is taken to the default “home” page for the geographic region which best matches the user's provided zip code, zip+4 or street address. FIG. 5 represents a web page for the preferred embodiment of the present invention illustrating a sample “home” page. Alternatively, the user may be given a choice of two or more cities in the vicinity of the provided zip code, zip+4 or street address. FIG. 6 represents a web page for the preferred embodiment of the present invention illustrating the “home” page choice screen.

The exact Internet address (or, in Internet parlance, Universal Resource Locator, or “URL”) of the default “home” page is determined by cross-referencing the User and Geo Tables to identify the appropriate city, state, latitude and longitude information for the user. From this information, the system generates a URL String which is an address that points to a web page displaying content about the geographic location of the user. This is the geographic location's “home” page.

The formatting of URL Strings is important. The URL String for United States cities, for example, is formatted generally as follows with variables enclosed in brackets: ({})

http://{IP}/geo/usa/states/{state}/cities/{city}/{channel or feature}/{input}

The variables embedded within the URL String are: (1) {IP} which is the root internet address of the web server within which the system operates, this variable is a standard internet address for the site hosting the system; (2) {state} which is replaced with the value contained in the “STATE” field for the Geo Table record corresponding to the user's zip, zip+4 or address; (3) {city} which is replaced with the value contained in the “CITY” field for the Geo Table record corresponding to the user's zip, zip+4 or address; (4) {channel or feature} which is the specific type of page which is to be displayed for the given state/city in question (for the default “home” page, this variable is initially set to “home” but can be one of a variety of different types of pages available for the given city/state combination); and (5) {input} which is the variable that is used to query Ad Table for advertisements which fall within the user's display (this variable normally consists of the user's zip code, +4, or street address but may also consist of the user's latitude/longitude information).

By way of example, if a first-time user were to access the system and enter the zip code “23506”, the system would create a new record in the User Table database and enter that number in the “ZIP” field. It would then query the Geo Table and: (a) determine that zip code 23506 corresponds to Norfolk, Va.; (b) determine the latitude and longitude for zip code 23506; and (c) write the latitude and longitude information to the user's record in the User Table database. Next, the system would generate a URL string as follows:

http://mycity.com/geo/usa/states/virginia/cities/norfolk/home/ZIP=23506

Using the URL String, the system begins generating the web page which is to be displayed to the user. This is done by assembling two types of content applicable to the page. The first type is generic content which relates to the channel or feature for the overall region selected for the user. In the above example that would be the “home” content for the city of Norfolk. The generic content may include, for example, summaries of news headlines, weather or other information that would be of interested to a resident of Norfolk, Virginia.

The second type of content is advertisement content which is identified within the Ad Table database as having a footprint that encompasses the specific location of the user. In the above example, this would include text and advertisements whose calculated display footprint would include the latitude/longitude location for the zip code included as the {input} field, in this example 23506.

From the “home” page, the user may select various features or channels (such as, for example, weather, business news, sports, shopping, and the like) other than the “home” page which are specifically tailored to the geographic region in question. As the user selects different channels or features within the “home” page, the URL String generated retains the structure of the “home” page URL String with the exception of the “channel or feature” variable which changes to match the selected Channel or Feature. So, continuing with the previous example, if the user from zip code 23506 were to select the weather Feature or Channel from the “home” page, the URL String generated by the system would be as follows:

http://mycity.com/geo/usa/states/virginia/cities/norfolk/weather/ZIP=23506

As a page is displayed to the user, the html code it contains may include instructions for the user's internet browser to re-load or “refresh” the page with newly available information. Similarly, the pages may include code to refresh the advertisement content by looking up a different advertisement in the Ad Table whose display footprint also includes the latitude/longitude location of the user. In this fashion, a rotation of geographically relevant advertisements is automatically established for each page displayed to the user.

One of the most important features of the present invention is the fact that only advertisement content whose display footprint encompasses the geographic location of the user will be displayed to the user. FIG. 7 illustrates the relationship between a particular advertisement's Base location, its radius, its display footprint and the location of the user. In FIG. 7, the base point 10 for a hypothetical advertisement is shown as well as the display radius 20. The display footprint 30 is the area encompassed by the circle 40 whose center is located at the base point 10 and whose radius is equal to the display radius 20. Two hypothetical users of the system are illustrated. User “A” 50 is located within the display footprint and therefore can be shown the subject advertisement. User “B” 60 is located outside the display footprint and therefore will not be shown the subject advertisement.

In order to determine whether a particular advertisement's display footprint encompasses the geographic location of the user, the present invention utilizes a Radius Algorithm. Integral to the Radius Algorithm is the well known formula used to determine the distance between two geographic points given their latitude and longitude coordinates. This general formula (hereinafter “Radial Distance Formula”) follows:

Radial Distance (in miles)=(3963.0×acos (sin ((Latₐ×π)/180)×sin ((Lat_{b}×π)/180)+cos ((Latₐ×π)/180)×cos((Lat_{b}×π)/180)+cos ((Long_{b}×π)/180−(Longₐ×π)/180)))

Where:

Latₐ=Latitude of point “a”

Longₐ=Longitude of point “a”

Lat_{b}=Latitude of point “b”

Long_{b}=Longitude of point “b”

acos, sin and cos=Standard trigonometric functions

The Radius Algorithm begins by obtaining the base latitude/longitude coordinates and the display radius for a candidate advertisement. Next, the latitude/longitude coordinates for the user are obtained. Using the Radial Distance Formula, the distance between the advertisement's base location and the user's location is calculated. Finally, the Radius Algorithm compares the length for the advertisement's display radius with the calculated distance between the user and the base location of the advertisement. If the display radius is greater that the calculated distance, the advertisement's footprint encompasses the user's location and the advertisement may be displayed. If the display radius is less that the calculated distance, the advertisement's footprint does not encompass the user's location and the advertisement is not displayed.

An advantage of the Radius Algorithm is that it can provide the user with a distance between his or her geographic location and the base location of the advertisement. It should be understood that the advertisement content displayed to the user need not be purely a commercial advertisement but can also be informational in nature. For example, the user may select a Feature or Channel called “restaurants” from the “home” page for his or her geographic location. The system can then display a list of advertisers who are restaurants and whose display footprint encompass the user. Such a display could contain information about the advertisers such as telephone numbers and addresses and, because their base distance to the user's location has already been calculated, can let the user know how close by they are. FIG. 8 represents a web page generated by the preferred embodiment of the present invention illustrating this feature.

It should also be understood that the advertisements displayed using the present invention can take many forms and need not necessarily be for physical businesses which bear a geographical relationship with the user. For example, an advertisement can consist of a traditional banner, a “sky scraper”, a website, and event listing, and the like, all of which are well know Internet advertisement methods. In addition, advertisers can be businesses and organizations which need not have a physical location at all (such as web-based businesses) but simply are interested in advertising to a population with a common geographical component.

Accordingly, it will be understood that the preferred embodiments of the invention have been disclosed by way of example and that other modifications and alterations may occur to those skilled in the art without departing from the scope and spirit of the appended claims.

1. A computer implemented method for providing online advertisement using radius-based algorithms and the geographic location of the targeted audience to specify what advertisements are displayed to users of the system comprising the steps of:
providing a web-implemented platform service comprised of online communities which is accessible to said users;
creating a geographic database containing information regarding the geographic location of said online communities;
creating and advertisement database containing advertisements wherein each said advertisement is assigned at least one geographic base location and at least one display radius;
creating a user database containing user records wherein each said user is permitted to join at least one said online community and is assigned a user geographic location in accordance thereto;
upon accessing of the web-implemented platform service by a user, selecting an advertisement from said advertisement database wherein said user's geographic location is encompassed by the geographic area delineated by a circle, said circle being centered at the geographic base location of said advertisement and said circle having a radius equal to said advertisement's display radius; and
displaying said advertisement to said user.
